(19) United States
(12) Patent Application Publication
(10) Pub. No.: US 2009/0327634 A1
(43) Pub. Date: Dec. 31, 2009

(54) SECURE CONFIGURATION OF TRANSIENT STORAGE DEVICES

(75) Inventor: James Bovee, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/145,524

(22) Filed: Jun. 25, 2008

(51) Int. Cl. G06F 12/14; G06F 12/00; G06F 3/00

(52) U.S. Cl. 711/163; 711/173; 710/8; 711/E12.093; 711/E12.001

(57) ABSTRACT

Extension fields in a provisioning certificate in the authentication silo of a transient storage device (TSD) are used to provide secure configuration options for TSDs while operating within the constraints of the current IEEE 1667 standard. Immutable values for configurable settings of the storage device are set in extension fields of a provisioning certificate. The provisioning certificate is then installed on the storage device. The method takes advantage of properties unique to the IEEE 1667 certificate silo specification and ITU-T X.509 certificate specification. The method is implemented while satisfying the security requirements for device configuration and taking advantage of the existing standards definitions as they are, without modification. The method allows particular features present in the device firmware to be enabled or disabled. An administrator may choose to set several device settings, for example, the number of addressable command targets (ACTs), the portion of total data storage area allocated to each ACT, and access settings. The method provides for these features to be implemented by the user, post retail sale, in a secure manner.

### BACKGROUND

Transient storage devices (TSDs) have come into widespread use for portable computer data storage in recent years. TSDs may take the form of universal serial bus (USB) flash drives and memory cards and “sticks” for mobile phones, digital cameras, personal digital assistants, digital music players (e.g., MP3 players), external hard drives and other portable devices. Because of the large storage capacity of and high speed of data transfer to and from TSDs, security of data stored on a TSD which may be transfered to and from host devices to which a TSD may be connected is a recognized concern. The Institute of Electrical and Electronics Engineers (IEEE) 1667 standard for TSDs addresses this concern by including the definition of a certificate silo for the purpose of authentication and subsequent authorization of access to user data on a TSD.

However, this standard lacks a general device configuration mechanism. An implementation of device configuration within the constraints of the current IEEE 1667 standard is complicated because the specification provides a limited set of authentication and certificate store management operations as implemented by the certificate silo. There are no operations in the IEEE 1667 standard specification intended for the purpose of device configuration. In particular, there is no construct at the provisioning level to configure the TSD. However, any configuration solution would need to operate within the parameters and requirements of the current IEEE 1667 standard specification.

### SUMMARY

Extension fields in a provisioning certificate in the authentication silo of a TSD are used to provide secure configuration options for TSDs while operating within the constraints of the current IEEE 1667 standard. In one implementation, immutable values for configurable settings of the storage device are set in extension fields of a provisioning certificate. The provisioning certificate is then installed on the storage device. The method takes advantage of properties unique to the IEEE 1667 certificate silo specification and ITU-T X.509 certificate specification in a unique way. The method is implemented while satisfying the security requirements for device configuration and taking advantage of the existing standards definitions as they are, without modification. Among other things, the method allows particular features present in the device firmware to be enabled or disabled. In particular, the method allows a user or administrator to choose among the several device settings, for example, the number of addressable command targets (ACTs), the portion of total data storage area allocated to each ACT, and access settings. The method provides for these features to be implemented by the user, post retail sale, in a secure manner.

For the purposes of this specification, the terms “transient storage device” and “TSD” encompass any device to which the IEEE 1667 standard may be applied as well as any storage device which may similarly accept the equivalent of a provisioning certificate that supports extension fields, for example, advanced technology attachment (ATA) devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 is a schematic diagram of several protocol layers of a transient storage device indicating one implementation of a possible configuration of the transient storage device.

FIG. 2 is a schematic diagram of the authentication silo of a transient storage device and an implementation using extension fields in a provisioning certificate to configure the transient storage device.

FIG. 3 is a flow diagram of an implementation of provisioning a transient storage device with a certificate that also configures the device.

### DETAILED DESCRIPTION

Device configuration is a privileged operation, one which the user of a device may not be authorized to perform. Therefore it must be performed in an elevated context in order to be secure against unauthorized execution. Device configuration may alter the behavior of the device in a manner that violates previous assumptions made about the device. For example, data may be placed into a secure area on the device with an expectation of continued secure access. However, that data may no longer be secure after the device undergoes a change in configuration settings. Therefore, device configuration should occur during an immutable initialization phase so that device behavior assumptions will not be violated by future changes to configuration.

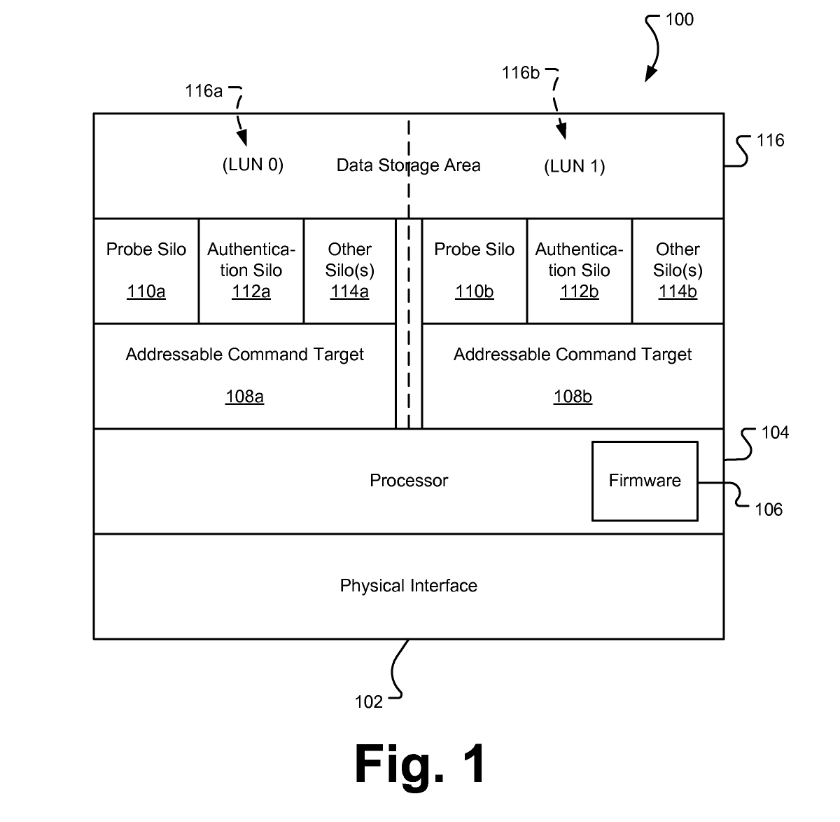

A transient storage device 100 or TSD is functionally divided into several different components as depicted in FIG. 1. The TSD 100 has a physical interface 102 to allow the TSD 100 to connect and communication with a host device. For example, a universal serial bus (USB) flash drive (UFD) generally has a box-shaped contact interface with 4 additional contact traces positioned on an insulator and surrounded by the rectangular contact. The TSD 100 further includes a processor 104 operating under control of embedded firmware 106 that executes data transfer, device configuration, and other functionality of the TSD 100. Each TSD 100 may have at least one and possibly more individually authenticated storage areas each accessed through an “addressable command target” (ACT) layer, which are similar in concept to “logical units” in other storage systems. FIG. 1 depicts a TSD 100 with a first ACT 108a and a second ACT 108b. Note that “authentication” is a separate concept from “authorization,” and authorization to access a particular storage area is dealt with separately.

Each ACT 108a, 108b implements several functional units called “silos” in the IEEE 1667 specification including at least a probe silo 110a, 110b and an authentication silo 112a, 112b. Each ACT 108a, 108b may implement additional manufacturer or user defined silos 114a, 114b. The ACT 104 and the corresponding silos provide configuration and authentication control to a data storage area 116 on the TSD 100.

The probe silos 110a, 110b are used by the host connected via the physical interface 102 to interrogate the ACTs 108a, 108b and identify the available functional units. The probe silos 108a, 108b in the TSD 100 receive an identification of the operating system and IEEE 1667 versions running or present on the host device. The probe silos 108a, 108b return the number, types, and versions of the silos implemented in each ACT 1108a, 108b. Interrogation of the probe silos 110a, 110b must occur before any further action can be taken with respect to any other silo.

Once the probe silos 108a, 108b receive and return the necessary device information, the authentication silos 112a, 112b for each ACT 108a, 108b provide the functions required for bidirectional authentication and administration of the authentication certificates. The authentication silos 112a, 112b use certificates to authenticate the host and each ACT 108a, 108b and also administers the certificates. Each of the probe silos 110a, 110b, the authentication silos 112a, 112b, and the other silos 114a, 114b is specific to a respective ACT 108a, 108b. As a general matter, the data storage area 116 is initially considered a single ACT or “logical unit” under the IEEE 1667 standard and is thus subject as a whole to any manufacturer certificates or provisioning certificates placed in and handled by the original or first authentication silo 112a. However, the first authentication silo 112a may be manipulated according to the methods described herein to partition the initial data storage area 116 into a number of ACTs 108a, 108b with separately accessible storage areas identified for convenience in the construct of logical unit numbers (LUN#), for example, LUN0 116a and LUN1 116b, as shown in FIG. 1.

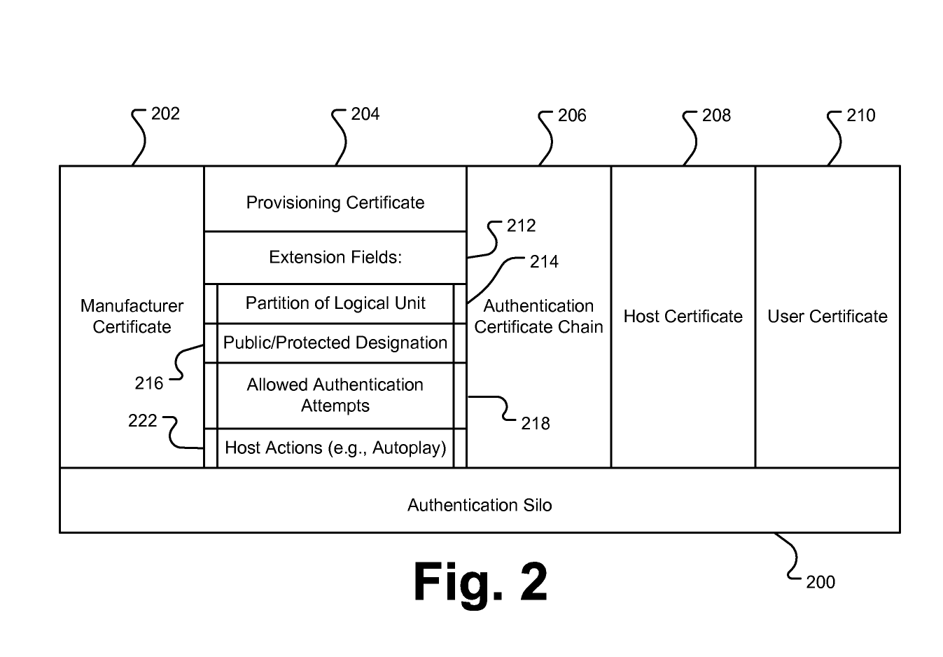

A more detailed description of an implementation of functional components of an authentication silo 200 is depicted in FIG. 2. Under the IEEE 1667 standard, five different types of certificates are defined: a manufacturer certificate 202, a provisioning certificate 204, an authentication certificate chain 206, a host certificate 208, and a user certificate 210. The manufacturer certificate 202 is mandatory and attests to the identity of the TSD. The manufacturer certificate 202 includes a unique identifier for the TSD and a public key that can be used to challenge the TSD. The authentication silo 200 of each ACT may each bear a unique manufacturer certificate 202 with a unique public key from a unique key-pair. The requirement, however, is that all manufacturer certificates chain to the same immediate parent certificate.

The provisioning certificate 204 grants administrative access to the authentication silo 200 and provides an administrator the ability to manage the remaining certificates. A user can only add, remove, or replace authentication certificates on a host that has access to a certificate signed by the provisioning certificate 204 stored in the authentication silo 200. The provisioning certificate 204 for the initial ACT is immutable and may be used to create a TSD that re-initializes into a new state containing multiple ACTs as the TSD is provisioned with the initial provisioning certificate 204. Extension fields 212 of the provisioning certificate 204 may be used to specify the details of this new state as further described below. Additional provisioning certificates may be provided specific to additional ACTs created by the initial provisioning certificate 204.

Once the ACT is provisioned, the TSD can store an authentication silo certificate chain 206. Users can use this chain to create personalized devices separate from all other devices with the same manufacturer and product identification numbers. The host can use the contents of the certificate chain 206 to authenticate the ACT and authorize access to storage in the ACT. Use of the certificate chain 206 in the context of the technology disclosed herein is further described below.

The host certificate 208 authenticates the host to the TSD when the TSD is attached. Multiple host certificates 208 may be added to the TSD corresponding to multiple host devices in which the TSD may be authenticated. Under the IEEE 1667 standard, if no host certificate is stored in the authentication silo 200, the TSD may automatically treat the host as authenticated indicating that limiting access to specific hosts is not intended. This simplifies configuration of the TSD when the manufacturer requires host authentication as a prerequisite for data access. The ACT will transition to an authenticated state when the host presents a certificate signed by one of the host certificates in the authentication silo.

User certificates 210 may also be placed in the authentication silo. User certificates 210 are not administered by the authentication silo 200. Under the IEEE 1667 standard any application can store or remove these certificates from the authentication silo 200. No further host certificates 208 or user certificates 210 may be added to the TSD unless the host or user certificate holder successfully authenticates using the provisioning certificate 204 placed on the TSD by the provisioner.

Under the IEEE 1667 standard, before a TSD may be used to provide secure access to data stored in the data storage area, it must undergo a set of operations that prepare it for that purpose. The IEEE 1667 standard specifies this process as provisioning. The provisioner of a TSD is not necessarily the user of that TSD. The provisioner is in effect the administrator for the TSD and may be the user, a system administrator, or the manufacturer.

In practice, the TSD arrives from the manufacturer in the non-provisioned state, with at least one ACT, the initial ACT(0) containing the authentication silo 200. The first provisioner of this ACT(0) may specify device global settings for the TSD in addition to ACT-specific settings. The global TSD settings are only configurable during first provisioning operation. Once placed on the TSD, the initial provisioning certificate 204 remains in effect and cannot be replaced unless the device is expressly re-initialized (i.e., reset to an original manufacturing state). Thus, once the configuration settings are specified, they can never be changed unless the TSD is reset back the manufactured state. This reset of the provisioning certificate 204 destroys all protected data so this data remains secure and resets any TSD configuration settings back to an initial state as at the time of manufacture. After a successful first provisioning, the TSD may now be in a state that it behaves differently or exposes additional ACTs above and beyond the original ones. Further provisioning of other ACTs by other provisioning certificates can never affect the global settings of the TSD set by the initial provisioning certificate 204, only ACT-specific settings. The TSD and the ACTs thereon remain secure due to the initial provisioning certificate 204 constraints.

The autonomous system number ASN.1 data type used to represent certificates following the International Telecommunication Union ITU-T X.509 standard is presented below. This is the format used for the provisioning certificate 204 of a TSD device according to the IEEE 1667 standard. As indicated, the data type provides for the use of extension fields near the end of the certificate. However, the extensions are deemed optional and are not further defined. Note that to allow for the presence of extension fields in the certificate, the version field must be set to version 3 (v3).

```
Certificate ::= SIGNED { SEQUENCE {
    version [0] Version DEFAULT v1,
    serialNumber CertificateSerialNumber,
    signature AlgorithmIdentifier,
    issuer Name,
    validity Validity,
    subject Name,
    subjectPublicKeyInfo SubjectPublicKeyInfo,
    issuerUniqueIdentifier [1] IMPLICIT UniqueIdentifier OPTIONAL,
                    -- if present, version shall be v2 or v3
    subjectUniqueIdentifier [2] IMPLICIT UniqueIdentifier OPTIONAL,
                    -- if present, version shall be v2 or v3
    extensions [3] Extensions OPTIONAL
                    -- If present, version shall be v3 -- } }
    Version ::= INTEGER { v1(0), v2(1), v3(2) }
    CertificateSerialNumber ::= INTEGER
AlgorithmIdentifier ::= SEQUENCE {
    algorithm ALGORITHM.&id ({SupportedAlgorithms}),
    parameters ALGORITHM.&Type ({SupportedAlgorithms}
    { @algorithm})
OPTIONAL }
    -- Definition of the following information object set is deferred,
perhaps to standardized
    -- profiles or to protocol implementation conformance statements.
The set is required to
    -- specify a table constraint on the parameters component of
    AlgorithmIdentifier.
    -- SupportedAlgorithms ALGORITHM ::= { ... }
Validity ::= SEQUENCE {
    notBefore Time,
    notAfter Time }
SubjectPublicKeyInfo ::= SEQUENCE {
    algorithm AlgorithmIdentifier,
    subjectPublicKey BIT STRING }
Time ::= CHOICE {
    utcTime UTCTime,
    generalizedTime GeneralizedTime }
Extensions ::= SEQUENCE OF Extension
Extension ::= SEQUENCE {
    extnId EXTENSION.&id ({ExtensionSet}),
    critical BOOLEAN DEFAULT FALSE,
    extnValue OCTET STRING
    -- contains a DER encoding of a value of type &ExtnType
    -- for the extension object identified by extnId -- }
ExtensionSet EXTENSION ::= { ... }
```

The present technology leverages the optional extension fields 212 in the provisioning certificate 204 to represent device configuration settings. While provisioning the TSD, the provisioner may elect to enable or disable various device settings that govern the behavior and performance of the TSD. The provisioner communicates these settings via ITU-T X.509 certificate extension fields 212 in the provisioning certificate 204. The ACT receives these settings during a set certificate command. The authenticity of these settings can be verified on the TSD by the certificate signature field which will not match the expected value if tampering has occurred.

The provisioner may discover available supported TSD configuration settings by retrieving the immutable and always accessible manufacturer certificate 202. The manufacturer certificate indicates the set of allowable configuration settings in the extension fields 212 of that certificate. The provisioner may parse these settings to determine which, if any, to include in the extension fields 212 of the provisioner certificate 204 during placement of the provisioning certificate 204 on the TSD. The configuration settings in the extension fields 212 of the provisioning certificate 204 will trump any default settings in the manufacturer certificate 202. The configuration settings in the extension fields 212 are immutable values in that they cannot be changed except by removal of the provisioning certificate 204, which results in the erasure of all data and certificates from the storage device.

Exemplary configuration settings that may be placed in the extension fields 212 of the provisioning certificate 204 are now described. The data storage area would by default be treated as a single logical unit. The configuration settings allow an administrator to choose among the several device settings, for example, the number of ACTs, the portion of total data storage area allocated to each ACT, and access settings. These configurations may thus be implemented by the user in the provisioning certificate, post retail sale, in a secure manner. A partition extension setting 214 may be used to partition the data storage area into multiple logical units (as depicted in FIG. 1). An exemplary partition extension setting 214 for creating multiple logical units in a TSD using the extension fields 212 of a provisioning certificate 204 may be as follows:
extnid=urn:oid:2.25.329800735698586629295641978511506172918
   critical=00
   extnValue=03
      where extValue denotes 3 ACTs allocated.

A public/protected extension setting 216 may also be desirable to designate the entire TSD, or individual ACTs, as publicly accessible or protected by a challenge, for example, by a passphrase. If the TSD is designated protected, the host may return an interface requesting a passphrase from the user for access to the TSD or an ACT thereof. Alternatively, the passphrase may be required in order to transfer certain data from the TSD to the host. Other functional components of the TSD could also be designated protected or public. For example, the host certificates 208 or user certificates 210, or certain ones thereof if placed during the provisioning process, could be designated protected and irremovable. An exemplary public/protected extension setting 216 for separately authenticating multiple logical units in a TSD using the extension fields 212 of a provisioning certificate 204 may be as follows:
extnid=urn:oid:2.25.329800735698586629295641978511506172919
critical=00
extnValue=00,01
   where extnValue denotes ACT0 is secure (whereas ACT1 and ACT2 are left public). Bit-field position value corresponds to ACT ordinal. Sixteen possible bit positions for 2 octets allows for specifying a protected/public (1/0) value for a maximum of 16 possible ACTs on the device.

In another example, an allowed authentication attempt extension setting 218 may be provided in an extension field 212. This setting may provide a maximum number of times that either an authentication certificate or authorization identification could be presented to the TSD by a user or host device in an attempt to read data from or write data to the TSD or a particular ACT. Repeated attempts at access without authentication or authorization may be indicative of an attempt to gain unauthorized access to the data for malicious purposes. Once the maximum attempt limit is reached, the provisioning certificate 204 may refuse any further attempts to access the data on the TSD, for example, without an administrative certificate. An exemplary authentication attempt extension setting 218 using the extension fields 212 of a provisioning certificate 204 may be as follows:
extnid=urn:oid:2.25.329800735698586629295641978511506172920
critical=00
extnValue=FF
   where extValue denotes 255 is the maximum number of attempts allowed.

In a further example, a host action extension setting 222 may be provided in an extension field 212 to trigger a host to perform some action when the TSD is connected to the host. For example, the host action extension setting 222 may cause the host to automatically play a certain file stored on the TSD, e.g., an installation file for an application, startup of a music playback program, or an audio/video tutorial regarding use of data on the TSD. An exemplary host action extension setting 222 using the extension fields 212 of a provisioning certificate 204 may be as follows:
extnid=urn:oid:2.25.329800735698586629295641978511506172921
critical=00
extnValue=5C,61,75,74,6F,70,6C,61,79,5C,72,65,63,2E,65,78,65,0D,0A
   where extnValue is a file system path pointing to “\autoplay\rec.exe”.

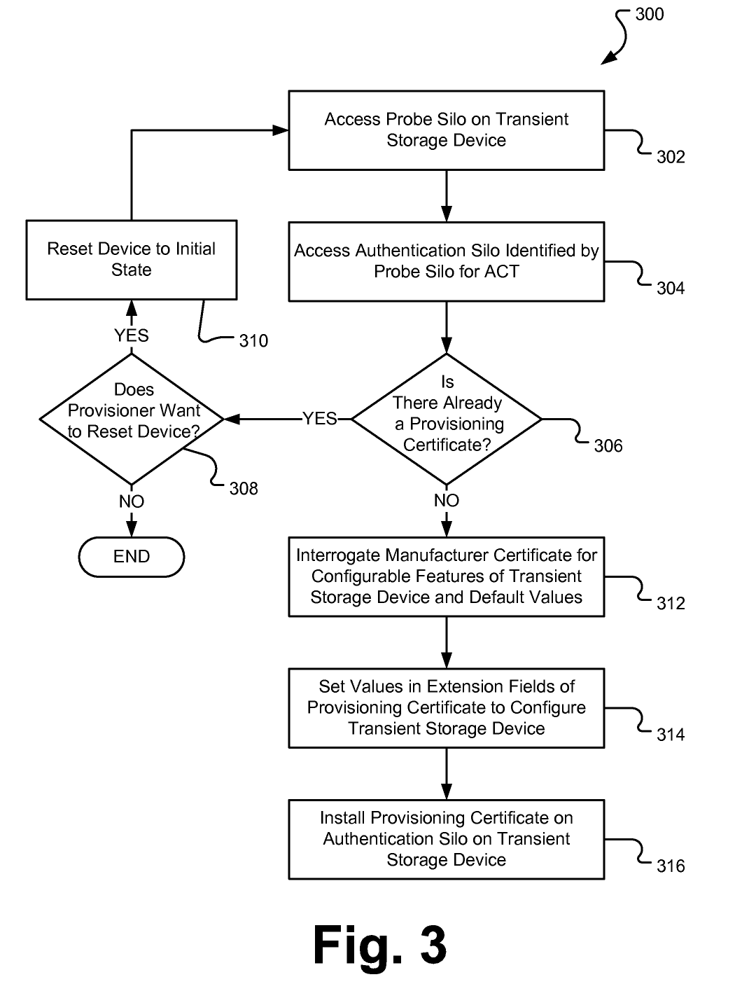

An exemplary configuration process 300 for implementing configuration settings in the extension fields of an initial provisioning certificate is presented in FIG. 3. In an accessing operation 302, the probe silo on a TSD is accessed by a host to interrogate the probe silo for numbers, types, and versions of silos. The host simultaneously provides operating system and IEEE 1667 version information particular to the host device. Using the silo information, the host next accesses the authentication silo based upon the identification information provided by the probe silo in a second accessing operation 304. Presuming this is a provisioning operation, the administrator or provisioner next determines whether there is already a provisioning certificate on the TSD as indicated in query operation 306.

If there is already a provisioning certificate on the TSD, the provisioner is challenged in query operation 308 to confirm that prior provisioning certificate should be removed and that the TSD should be reset to original manufacture specifications. Recall that removal of the provisioning certificate will erase any data and certificates presently stored on the TSD. This is a very drastic operation and therefore provides a high level of security to prevent changes to the configuration settings that may have been applied in a prior provisioning certificate. If the provisioner decides not to remove a present provisioning certificate, the provisioning configuration method 300 terminates. If the provisioner decides to remove the prior provisioning certificate and replace it with a new provisioning certificate, the TSD is reset to an initial state an all data and certificates, other than the manufacturer certificate are erased from the TSD as indicated by resetting operation 308. The configuration process 300 then returns to the first accessing operation 302 to begin the provisioning process.

Returning to the first query operation 306, if it is determined that there is no provisioning certificate, either because this is the first time the TSD has been provisioned or because a prior provisioning certificate was removed, the configuration process 300 continues. The provisioner may first interrogate the manufacturer certificate to determine what functionality is available for the particular TSD and return the default settings in interrogation operation 312. As part of setting the provisioning certificate, the provisioner then additionally sets values in the extension fields of the provisioning certificate to provide configuration settings that will control access to and functionality of the TSD as indicated in setting operation 314. Finally, the completed provisioning certificate, including populated extension fields, is installed on the authentication silo on the TSD as indicated in providing operation 316. The provisioning and secure configuration of the TSD is now complete.

As noted above, under the IEEE 1667 standard the configuration settings in the provisioning certificate are immutable once set unless the provisioning certificate is completely removed, which in turn will erase all data on the TSD. The extension settings in the extension fields of the provisioning certificate provide the ability to configure a highly secure TSD that allows a range of access from depending upon the host device that the TSD is used in. The inability to change the provisioning certificate and the drastic effect on the TSD if the provisioning certificate is removed ensures that the configuration settings provided according to this methodology are also immutable and protected from any future changes.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products. In one implementation, a computer program product is provided as a computer-readable medium storing encoded computer program instructions executable by a computer system. Another implementation of a computer program product may be provided in a computer data signal embodied in a carrier wave by a computing system and encoding the computer program. Other implementations are also described and recited herein.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for configuration of a storage device comprising
setting immutable values for configurable settings of the storage device in extension fields of a provisioning certificate; and
installing the provisioning certificate on the storage device.

2. The method of claim 1 further comprising
determining a presence of a prior provisioning certificate on the storage device; and
removing the prior provisioning certificate from the storage device.

3. The method of claim 1 further comprising interrogating a manufacturer certificate to identify the configurable settings of the storage device.

4. The method of claim 1 further comprising selecting immutable values that cause a partition of a data storage area on the storage device into two or more addressable command targets with allocated portions of the data storage area.

5. The method of claim 4 further comprising selecting immutable values that restrict access to each of the addressable command targets to separate authentication certificates.

6. The method of claim 4 further comprising selecting immutable values that designate one or more of the addressable command targets as protected to require authenticaion and subsequent access to the designated addressable command targets.

7. The method of claim 1 further comprising selecting immutable values that instantiate an action by a host device upon connection between the host device and the storage device.

8. A computer-readable medium storing computer-executable instructions for performing a computer process to control a computing system, wherein the instructions comprise operations to
set immutable values for configurable settings of a storage device in extension fields of a provisioning certificate; and
install the provisioning certificate on the storage device.

9. The computer-readable medium of claim 8, wherein the instructions further comprise operations to
determine a presence of a prior provisioning certificate on the storage device; and
remove the prior provisioning certificate from the storage device.

10. The computer-readable medium of claim 8, wherein the instructions further comprise operations to interrogate a manufacturer certificate to identify the configurable settings of the storage device.

11. The computer-readable medium of claim 8, wherein the instructions further comprise operations to select immutable values that cause a partition of a data storage area on the storage device into two or more addressable command targets with allocated portions of the data storage area.

12. The computer-readable medium of claim 11, wherein the instructions further comprise operations to select immutable values that restrict access to each of the addressable command targets to separate authentication certificates.

13. The computer-readable medium of claim 11, wherein the instructions further comprise operations to select immutable values that designate one or more of the addressable command targets as protected to require authorization for access to the designated addressable command targets.

14. The computer-readable medium of claim 8, wherein the instructions further comprise operations to select immutable values that instantiate an action by a host device upon connection between the host device and the storage device.

15. A storage device comprising
a processor;
a data storage area;
a manufacturer certificate stored on the data storage area that defines one or more configurable settings of the storage device;
a provisioning certificate stored on the data storage area that provides one or more immutable setting values for the configurable setting; and
a firmware application running on the processor that restricts operations of the processor based upon the immutable setting values.

16. The storage device of claim 15, wherein
the provisioning certificate further comprises one or more extension fields; and
the immutable setting values are stored within the extension fields.

17. The storage device of claim 15, wherein the immutable setting values direct the processor to partition the data storage area into two or more addressable command targets with allocated portions of the data storage area.

18. The storage device of claim 17, wherein the immutable setting values further direct the processor to restrict access to each of the addressable command targets to separate authentication certificates.

19. The storage device of claim 17, wherein the immutable setting values further direct the processor to designate one or more of the addressable command targets as protected to require authorization for access to the designated addressable command targets.

20. The storage device of claim 15, wherein the immutable setting values further cause instantiation of an action by a host device upon connection between the host device and the storage device.
